(19) United States
(12) Patent Application Publication
(10) Pub. No.: US 2006/0173860 A1
(43) Pub. Date: Aug. 3, 2006

(54) Information processing system, server apparatus and client terminal apparatus

(76) Inventors: Hayato Ikebe, Higashiosaka-City (JP); Kazuya Ogawa, Mizuho-City (JP); Yoshinori Hatayama, Komaki-City (JP); Hiroshi Takemura, Aisai-City (JP); Youko Tanaka, Mizuho-City (JP)

Correspondence Address: MCDERMOTT WILL & EMERY LLP, 600 13TH STREET, N.W., WASHINGTON, DC, 20005-3096, US

(21) Appl. No.: 11/331,446

(22) Filed: Jan. 13, 2006

(30) Foreign Application Priority Data
Jan. 13, 2005 (JP) P2005-006795
Jan. 14, 2005 (JP) P2005-008384

(51) Int. Cl. G06F 17/30

(52) U.S. Cl. 707/10

(57) ABSTRACT

A server apparatus according to the present invention receives a time-out period information indicating a time-out period used for judging that a connection with a client terminal apparatus is disconnected, and also receives connection-continuation information indicating that the connection is continued. If the server apparatus cannot receive the connection-continuation information within the time-out period indicated by the time-out period information, the server apparatus judges that the connection is disconnected.

### CROSS REFERENCE TO RELATED APPLICATIONS

This application is based upon and claims the benefit of priority from the prior Japanese Patent Applications No. P2005-006795 filed on Jan. 13, 2005 and P2005-008384 filed on Jan. 14, 2005; the entire contents of which are incorporated herein by reference.

### BACKGROUND OF THE INVENTION

1. Field of the Invention

The present invention relates to an information processing system, a server apparatus, and a client terminal apparatus, which detect a disconnection of a logical connection between the server apparatus and the client terminal apparatus.

The present invention also relates to an information processing system, a server apparatus, and a client terminal apparatus, which limit a number of client terminal apparatuses connected with the server apparatus to the maximum number of client terminal apparatuses connectable to the server apparatus.

2. Description of the Related Art

Conventionally, in a general information processing system including a server apparatus and client terminal apparatuses (a client server system), it sometimes happens that a power source for the client terminal apparatus is shut off or the client terminal apparatus is isolated from a communication network while the client terminal apparatus has not yet disconnected a logical connection with the server apparatus.

In these cases, there arises a problem because the server apparatus recognizes that the connection with the client terminal apparatus is continued even though the client terminal apparatus is not in a state where the connection is continued.

Consequently, there has been disclosed a method of determining a threshold value in a server apparatus, which is used for judging that a connection with the client terminal apparatus is disconnected based on an actually measured value for a interval between transmissions of information (request or the like) transmitted by a client terminal apparatus (see Japanese Unexamined Patent Publication No. H11-161577 (page 4, FIG. 4)).

According to this method, if information has not been transmitted from a client terminal apparatus to the server apparatus after a transmission interval (time period) set as the threshold value has elapsed, the server apparatus judges that a connection with the client terminal apparatus is disconnected, and a process of releasing the connection can be executed.

### BRIEF SUMMARY OF THE INVENTION

Incidentally, in recent years, a home network has been in practical use. The home network is a communication network for connecting client terminal apparatuses such as a security camera and a sensor which are installed in a house.

With the home network as described above, client terminal apparatuses of various kinds are connected. Some of these client terminal apparatuses have relatively long intervals between transmissions of information to a server apparatus.

For example, a temperature sensor does not transmit any information unless a measured temperature changes. On the other hand, a security camera and the like, which are connected with the home network, need to promptly detect that an intruder or the like shuts down its power source without an authorization or disconnects its physical connection with the home network.

Specifically, in the abovementioned conventional method there has been a problem that it requires a long time to detect a disconnection of a connection with a client terminal apparatus which has a long interval between information transmissions.

The present invention has been made in view of the above-described circumstance. An object of the present invention is to provide an information processing system, a server apparatus, and a client terminal apparatus, which can more promptly detect a disconnection of a logical connection between the server apparatus and the client terminal apparatus.

To attain the object, the present invention provides the following aspects. A first aspect of the present invention provides an information processing system including a server apparatus and a client terminal apparatus which establishes a connection with the server apparatus through a communication network. The client terminal apparatus includes a time-out period information transmitter configured to transmit a time-out period information indicating a time-out period used for judging that the connection has been disconnected from the server apparatus, and a connection-continuation information transmitter configured to transmit a connection-continuation information indicating that the connection to the server apparatus is continued within the time-out period. The server apparatus includes an information receiver configured to receive the time-out period information and the connection-continuation information, and a disconnection judger configured to judge that the connection is disconnected if the information receiver cannot receive the connection-continuation information within the time-out period indicated by the time-out period information.

According to this aspect, the connection-continuation information is transmitted periodically from the client terminal apparatus to the server apparatus within the time-out period used for judging that a connection (a logical connection) between the client terminal apparatus and the server apparatus is disconnected. Therefore, when the server apparatus cannot receive the connection-continuation information within the time-out period, the server apparatus can promptly judge that the connection is disconnected.

In other words, according to the above aspect, even in a case where an interval between transmissions of information transmitted by the client terminal apparatus to the server apparatus is long, the server apparatus can promptly detect a disconnection of a logical connection between the client terminal apparatus and the server apparatus.

A second aspect of the present invention relates to the first aspect of the invention, and the server apparatus further includes a response transmitter configured to transmit a connection-continuation-information-reception response corresponding to received connection-continuation information to the client terminal apparatus. The client terminal apparatus further includes a response receiver configured to receive the connection-continuation-information-reception response transmitted by the response transmitter, and a client-side disconnection judger configured to judge that the connection is disconnected in a case where the response receiver cannot receive the connection-continuation-information-reception response transmitted next to the already received connection-continuation-information-reception response within a predetermined period after receiving an already received connection-continuation-information-reception response by the response receiver.

A third aspect of the present invention relates to any one of the first and second aspects of the invention, and the server apparatus further includes a disconnection alarm unit configured to issue an alarm that the connection is disconnected if the disconnection judger has judged that the connection is disconnected.

A fourth aspect of the present invention relates to any one of the second and third aspects of the invention, and the information processing system of claim 2, the client terminal apparatus further includes a client-side disconnection alarm unit configured to issue an alarm that the connection is disconnected if the client-side disconnection judger has judged that the connection is disconnected.

A fifth aspect of the present invention relates to any one of the second to fourth aspects of the invention, and the client terminal apparatus further includes a connection establishment unit configured to establish a connection with a different server apparatus connected with the communication network if the client-side disconnection judger has judged that the connection is disconnected.

A sixth aspect of the present invention provides a server apparatus which establishes a connection with client terminal apparatuses through a communication network. The server apparatus includes an information receiver configured to receive a time-out period information indicating a time-out period used for judging that the connection is disconnected, and a connection-continuation information indicating that the connection is continued, and a disconnection judger configured to judge that the connection is disconnected if the information receiver cannot receive the connection-continuation information within the time-out period indicated by the time-out period information.

A seventh aspect of the present invention relates to the sixth aspect, and the server apparatus further includes a response transmitter configured to transmit a connection-continuation-information-reception response corresponding to received connection-continuation information to the client terminal apparatus.

An eighth aspect of the present invention relates to any one of the sixth and seventh aspects of the invention, and the server apparatus further includes a disconnection alarm unit configured to issue an alarm that the connection is disconnected if the disconnection judger has judged that the connection is disconnected.

A ninth aspect of the invention provides a client terminal apparatus which establishes a connection with a server apparatus through a communication network. The client terminal includes a time-out period information transmitter configured to transmit a time-out period information indicating a time-out period used for judging that the connection is disconnected from the server apparatus, and a connection-continuation information transmitter configured to transmit a connection-continuation information indicating that the connection to the server apparatus is continued within the time-out period.

A tenth aspect of the present invention relates to the ninth aspect, and the client terminal apparatus further includes a response receiver configured to receive the connection-continuation-information-reception response transmitted by the server apparatus, and a client-side disconnection judger configured to judge that the connection is disconnected in a case where the response receiver cannot receive the connection-continuation-information-reception response transmitted next to the already received connection-continuation-information-reception response within a predetermined period after receiving an already received connection-continuation-information-reception response by the server apparatus.

An eleventh aspect of the present invention relates to the tenth aspect of the invention, and the client terminal apparatus further includes a client-side disconnection alarm unit configured to issue an alarm that the connection is disconnected if the client-side disconnection judger has judged that the connection is disconnected.

A twelfth aspect of the present invention relates to any one of the tenth and eleventh aspects of the invention, and the client terminal apparatus further includes a connection establishment unit configured to establish a connection with a different server apparatus connected with the communication network if the client-side disconnection judger has judged that the connection is disconnected.

According to the aspects of the present invention, it becomes possible to provide an information processing system, a server apparatus, and a client terminal apparatus, which can more promptly detect a disconnection of a logical connection between the server apparatus and the client terminal apparatus.

### BRIEF DESCRIPTION OF THE DRAWINGS

FIG. 1 is an overall schematic configuration diagram of an information processing system according to a first embodiment of the present invention.

FIG. 2 is a view showing a logical block configuration of a server apparatus according to the first embodiment of the present invention.

FIG. 3 is a view showing a logical block configuration of a client terminal apparatus according to the first embodiment of the present invention.

FIG. 4 is a view showing a process flow executed by the client terminal apparatus according to the first embodiment of the present invention.

FIG. 5 is a view showing a process flow executed by the server apparatus according to the first embodiment of the present invention.

FIG. 6 is a view showing a communication sequence when the information processing system according to the first embodiment of the present invention is normal.

FIG. 7 is a view showing a communication sequence when the information processing system according to the first embodiment of the present invention is not normal.

FIG. 8 is a view showing a communication sequence when the information processing system according to the first embodiment of the present invention is not normal.

FIG. 9 is an overall schematic configuration diagram of an information processing system according to a second embodiment of the present invention.

FIG. 10 is a view showing a logical block configuration of a server apparatus according to the second embodiment of the present invention.

FIG. 11 is a view showing a logical block configuration of a client terminal apparatus according to the second embodiment of the present invention.

FIG. 12 is a sequence diagram showing an outline of contents of a process performed by the information processing system according to the second embodiment of the present invention.

FIG. 13 is a view showing an overall process flow executed by the client terminal apparatus according to the second embodiment of the present invention.

FIG. 14 is a view showing a process flow executed by the server apparatus according to the second embodiment of the present invention.

FIG. 15 is a view showing a process flow executed by the server apparatus according to the second embodiment of the present invention.

FIGS. 16A and 16B are views respectively showing examples of a network connection advertisement (an advertise message) and a connection number advertisement (a subscribe message) according to the second embodiment of the present invention.

### DESCRIPTION OF THE PREFERRED EMBODIMENTS

Next, embodiments of the present invention will be described below. Note that, in the following description of the drawings, the same or similar parts will be denoted by the same or similar reference numerals. However, the drawings are schematic and actual proportions of dimensions and the like are different from reality.

It is therefore recommended to determine the concrete dimensions and other features in consideration of the following description. Moreover, it is needless to say that dimensional relations or proportion may vary between the drawings.

### First Embodiment

(Overall Schematic Configuration of Information Processing System)

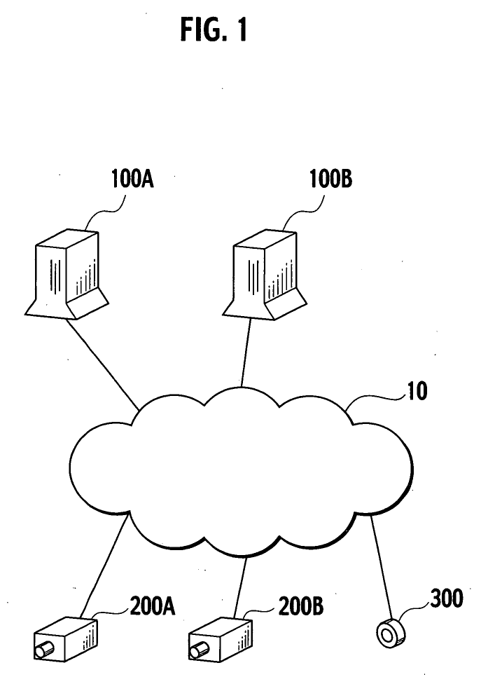

FIG. 1 shows an overall schematic configuration diagram of an information processing system according to a first embodiment of the present invention. As shown in the drawing, the information processing system according to this embodiment includes servers 100A and 100B and client terminals 200A, 200B, 300 each of which establishes a logical connection with the servers 100A and 100B through a home network 10.

The servers 100A and 100B (server apparatuses) establishes a connection with the client terminals 200A, 200B and 300 through the home network 10, and executes predetermined information processing by using information transmitted by the client terminals 200A, 200B and 300.

The client terminals 200A and 200B (client terminal apparatuses) establishes a connection with anyone of the servers 100A and 100B through the home network 10. In this embodiment, the client terminals 200A and 200B is provided with a security camera capable of capturing a location and its surroundings where the client terminal is placed.

The client terminal 300 (a client terminal apparatus) is provided with a sensor which measures a temperature and the like of a location where the client terminal 300 is installed.

The home network 10 (a communication network) is a communication network for connecting the servers 100A and 100B with the client terminals 200A, 200B and 300. The home network 10 may be formed by use of a LAN (such as 100BASE-TX) installed in a building (such as a house). Note that the home network 10 may include a wireless LAN, and the home network 10 may be connected to a wide area network (WAN) or to the Internet.

(Logical Block Configuration)

Next, logical block configurations of the respective servers 100A and 100B and client terminals 200A, 200B and 300, which constitute the abovementioned information processing system will be described.

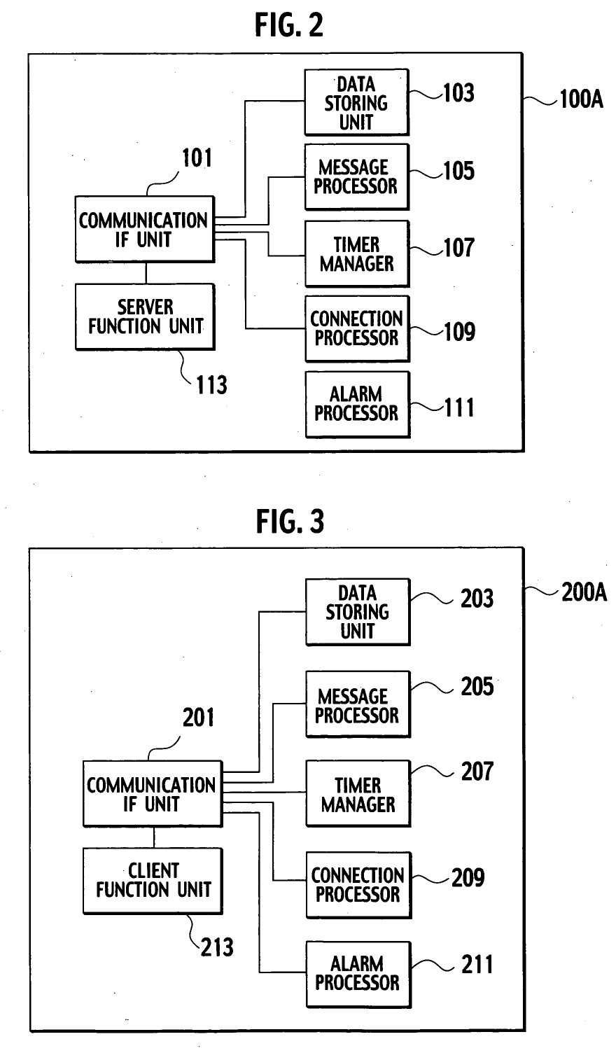

FIG. 2 shows a logical block configuration of the server 100A. The server 100B also has a similar logic block configuration to the server 100A.

FIG. 3 shows a logical block configuration of the client terminal 200A. Note that the client terminals 200B and 300 have a similar logic block configuration to the client terminal 200A.

Now, portions related to the present invention will be mainly explained below. Accordingly, it should be noted that the server 100A shown in FIG. 2 and the client terminal 200A shown in FIG. 3 may further include un-illustrated or unexplained logic blocks (such are a power unit and the like) which are essential for realizing the features of the apparatuses.

(1) Server

As shown in FIG. 2, the server 100A includes a communication IF unit 101, a data storing unit 103, a message processor 105, a timer manager 107, a connection processor 109, an alarm processor 111 and a server function unit 113.

The communication IF unit 101 provides a communication interface whereby the server 100A connects with the home network 10. Specifically, the communication IF unit 101 is provided with a LAN interface (such as 100BASE-TX).

Further, the communication IF unit 101 is connected with logical blocks of the data storing unit 103, the message processor 105, the connection processor 109, the alarm processor 111 and the server function unit 113. The communication IF unit 101 relays data transmitted and received among these logical blocks and the home network 10.

The data storing unit 103 stores information such as “time-out period information” (hereinafter referred to as “TOPI”) included in advertise messages transmitted from the client terminals.

If the message processor 105 has received from the client terminal (for example, the client terminal 200A) an advertise message, which advertises TOPI indicating a time-out period (for example, 30 seconds) for the client terminal, the message processor 105 stores in the data storing unit 103 the TOPI.

In particular, the message processor 105 receives the TOPI indicating a time-out period (for example, 30 seconds) used for judging that a connection with a client terminal is disconnected. Further, the message processor 105 receives “connection-continuation information” (hereinafter referred to as “CCI”) transmitted by a client terminal within the time-out period. The CCI indicates that a connection with the client terminal is continued. In this embodiment, the message processor 105 constitutes an information receiver.

Further, the message processor 105 transmits to the client terminal a “connection-continuation-information-reception response” (hereinafter referred to as “CCIRR”) as a response corresponding to reception of the CCI. In this embodiment, the message processor 105 constitutes a response transmitter.

The timer manager 107 manages intervals between receptions of information received by the message processor 105, i.e., the CCI or normal information (data on moving picture captured by the security camera which the client terminal 200A is provided with).

Specifically, if an interval between receptions of either CCI or normal information received by the message processor 105 has become the time-out period or longer, the timer manager 107 informs the connection processor 109 that the reception interval has become the time-out period or longer.

The connection processor 109 executes a process of establishing and releasing a logical connection with a client terminal connected to the server 100A (for example, the client terminal 200A).

In particular, if the message processor 105 can receive neither CCI nor normal information within the time-out period indicated in the advertise message, the connection processor 109 judges that the connection with the client terminal is disconnected. In this embodiment, the connection processor 109 constitutes a disconnection judger.

If the connection processor 109 has judged that a connection with a client terminal is disconnected, the alarm processor 111 signals that the connection is disconnected. In this embodiment, the alarm processor 111 constitutes a disconnection alarm unit.

Specifically, if the connection processor 109 has judged that a connection with a client terminal is disconnected, the alarm processor 111 can transmit a command for staring up an alarm device (not illustrated) such as a siren, with which the server function unit 113 is provided. Note that, instead of providing the server function unit 113 with the alarm device, the alarm device may be configured so as to be accessible via the home network 10.

If the connection processor 109 has judged that a connection with a client terminal is disconnected, the alarm processor 111 can also transmit an e-mail indicating that the disconnection to a mobile phone terminal (not illustrated) and a security company, with which communications are possible via the home network 10.

The server function unit 113 provides functions of the server. Specifically, the server function unit 113 performs a start-up process including resetting the respective logical blocks when the server 100A is turned on.

Further, the server function unit 113 executes processing on information transmitted by the client terminals, and storing the information in the data storing unit 103.

Moreover, the server function unit 113 is provided with an alarm device such as a siren, whereby the server function unit 113 can issue an alarm that a connection with a client terminal is disconnected.

(2) Client Terminal

As shown in FIG. 3, the client terminal 200A includes a communication IF unit 201, a data storing unit 203, a message processor 205, a timer manager 207, a connection processor 209, an alarm processor 211 and a client function unit 213.

The communication IF unit 201 provides a communication interface whereby the client terminal 200A is connected with the home network 10. Specifically, the communication IF unit 201 is provided with a LAN interface (such as 100BASE-TX).

Further, the communication IF unit 201 is connected with logical blocks of the data storing unit 203, the message processor 205, the connection processor 209, the alarm processor 211 and the client function unit 213. The communication IF unit 201 relays data transmitted and received among these logical blocks and the home network 10.

The data storing unit 203 stores information such as a value for the TOPI used for enabling a server (for example, the server 100A) to judge that a connection of the client terminal 200A with the server is disconnected.

The message processor 205 generates an advertise message (time-out period information) and CCI. The message processor 205 transmits the generated advertise message and the CCI to a server (for example, the server 100A). Further, the message processor 205 receives a CCIRR and the like which are transmitted by a server.

In this embodiment, the message processor 205 constitutes a time-out period information transmitter which transmits time-out period information used for enabling a server to judge that a connection with the server is disconnected.

Further, the message processor 205 constitutes a connection-continuation information transmitter which transmits “CCI” indicating that the connection is continued to the server within a time-out period indicated by TOPI.

Further, the message processor 205 constitutes a response receiver which receives a CCIRR transmitted by a server (for example, the server 100A).

The timer manager 207 manages CCIRRs and responses corresponding to normal information. Specifically, if the timer manager 207 cannot receive a CCIRR or a response corresponding to normal information, which is received by the message processor 205 within a predetermined time period, the timer manager 207 informs the connection processor 209 that a CCIRR cannot be received.

The connection processor 209 executes a process of establishing and releasing a logical connection with a server (for example, the server 100A).

Particularly, under a specific condition the connection processor 209 judges that a connection with the server is disconnected. The specific condition being that when the message processor 205 cannot receive a CCIRR or a response corresponding to the normal information, which the server transmits next to the already received CCIRR within a predetermined time period (for example, 30 seconds) after receiving the already received CCIRR or a response corresponding to the normal information received by the message processor 205. In this embodiment, the connection processor 209 constitutes client-side disconnection judger.

In addition, if the connection processor 209 has judged that a connection with a server (for example, the server 100A) is disconnected, the connection processor 209 can newly establish a connection with a different sever (the server 100B) connected to the home network 10. In this embodiment, the connection processor 209 constitutes a connection establishment unit.

If the connection processor 209 has judged that a connection with the server is disconnected, the alarm processor 211 issues an alarm that the connection is disconnected. In this embodiment, the alarm processor 211 constitutes a client-side disconnection alarm unit.

Specifically, if the connection processor 209 has judged that a connection with the server is disconnected, the alarm processor 211 can transmit a command for starting up an alarm device (not illustrated) such as a siren, with which the client function unit 213 is provided. Note that, instead of providing the client function unit 213 with the alarm device, the alarm device may be configured so as to be accessible via the home network 10.

Further, if the connection processor 209 has judged that a connection with the server is disconnected, the alarm processor 211 can also transmit an e-mail indicating the disconnection to a mobile phone terminal (not illustrated) and a security company, with which communications are possible via the home network 10.

Note that the alarm processor 211 may be configured to issue the alarm when the connection processor 209 cannot establish a connection with a different sever while it has been judged that a connection with a server (for example, the server 100A) is disconnected.

The client function unit 213 provides functions of a client terminal. Specifically, the client function unit 213 performs a start-up process including resetting the respective logical blocks when the client terminal 200A is turned on.

The client function unit 213 is provided with a security camera function, and provides a function of transmitting captured moving picture data to the servers. Note that, in the case of the client terminal 300, a sensor function of measuring a temperature or the like is provided instead of the security camera function.

Further, the client function unit 213 is provided with an alarm device such as a siren, whereby the client function unit 213 can issue an alarm that a connection with the client terminal is disconnected.

(Operations of the Information Processing System)

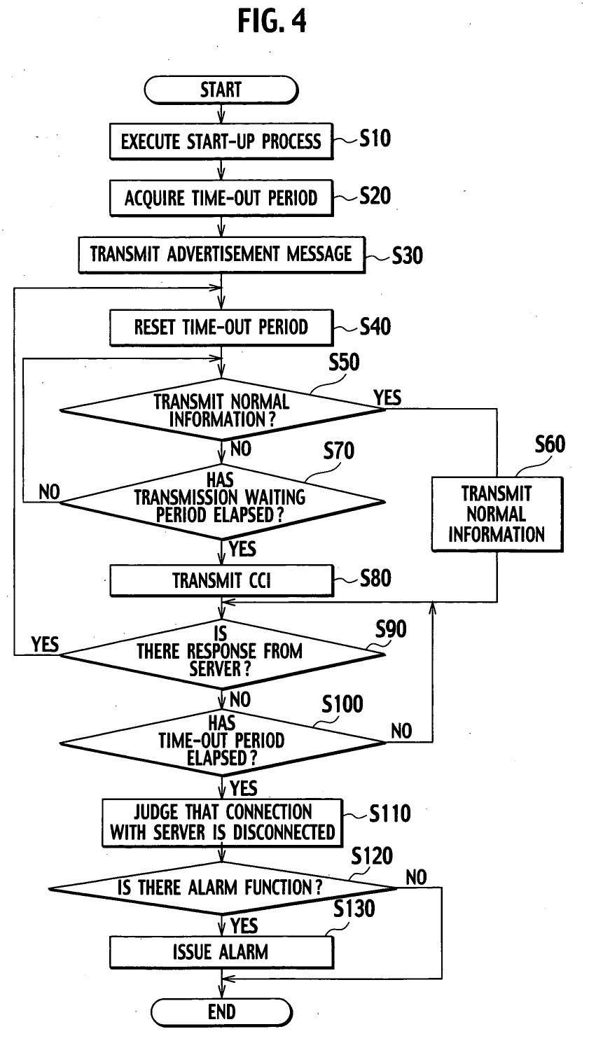

Next, operations of the information processing system of this embodiment will be described with reference to FIG. 4 to FIG. 8. Note that operations of the information processing system according to this embodiment will be described by taking as an example of a process between the server 100A and the client terminal 200A.

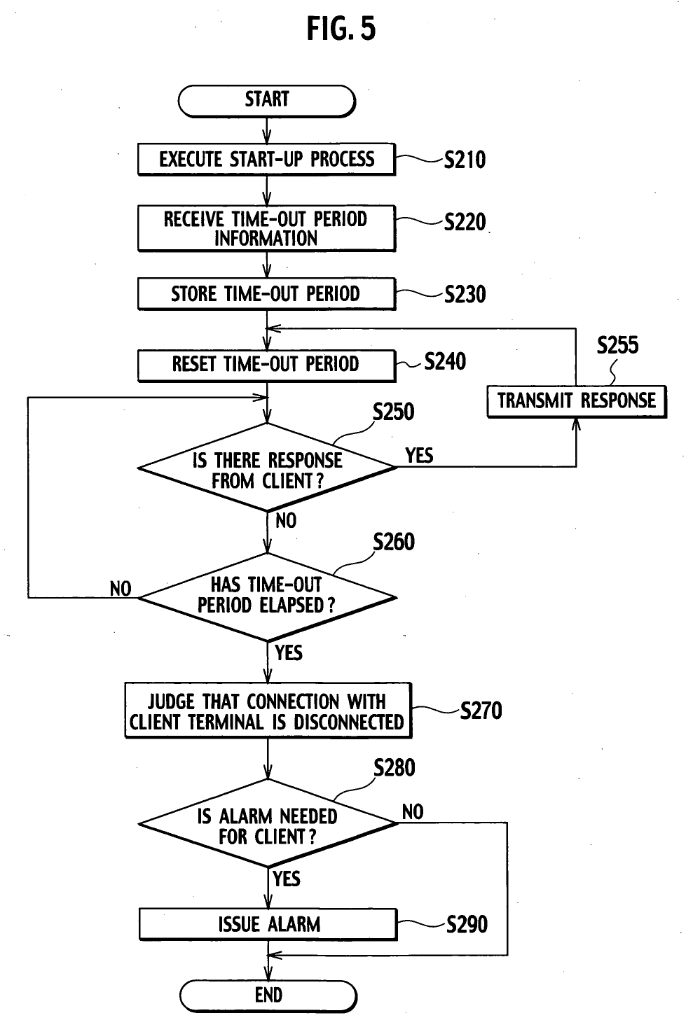

FIG. 4 shows a process flow to be executed by the client terminal 200 A, and FIG. 5 shows a process flow to be executed by the server 100 A.

(1) Client Terminal

First, with reference to FIG. 4, processing contents executed by the client terminal 200A will be described. As shown in the drawing, in Step S10, the client terminal 200A executes a start-up process. Specifically, the client terminal 200A executes a process such as initialization of the respective logical blocks constituting the client terminal 200A.

In Step S20, the client terminal 200A acquires from the data storing unit 203 a time-out, period (for example, 30 seconds) used for enabling the server 100A to judge that a connection with the server 100A is disconnected.

In Step S30, the client terminal 200A generates an advertise message including TOPI indicating the acquired time-out period, and transmits the advertise message to the server 100A.

In Step S40, the client terminal 200A resets a measurement of time-out period used for judging an interval between receptions of CCIRRs.

That is, if the server 100A has received CCI from the client terminal 200A, the server 100A transmits to the client terminal 200A a CCIRR as a response to the CCI.

Subsequently, the client terminal 200A resets a measurement of time-out period used for judging an interval between receptions of CCIRRs.

In Step 50, the client terminal 200A judges whether there is normal information which causes a response immediately (for example, moving picture data captured by a security camera, with which the client terminal 200A is provided) required to be transmitted to the server 100A other than CCI.

If there is the normal information required to be transmitted to the server 100A (“Yes” in Step S50), in Step S60, the client terminal 200A transmits the normal information to the server 100A.

If there is no normal information required to be transmitted to the server 100A (“No” in Step S50), in Step S70, the client terminal 200A judges whether a transmission waiting period for CCI has elapsed.

If the transmission waiting period for CCI has elapsed (“Yes” in Step S70), in Step S80, the client terminal 200A transmits CCI to the server 100A.

In Step S90, the client terminal 200A judges whether there has been a response from the server 100A. Further, the client terminal 200A judges whether it has received a response corresponding to the normal information transmitted in Step S60 or a CCIRR transmitted by the server 100A next to a previously (last) received CCIRR (an already received CCIRR).

If there is no response from the server 100A (“No” in Step S90), in Step S100, the client terminal 200A judges whether the time-out period has elapsed.

If the time-out period has elapsed (“Yes” in Step S100), in Step S110, the client terminal 200A judges that the connection with the server 100A is disconnected.

Incidentally, main causes for disconnection of a logical connection with the server 100A are physical isolation of the server 100A from the home network 10 and shutoff of a power source for the server 100A without a proper releasing process.

More specifically, it can be detected that the server 100A is handled illegally by an intruder or the like who has intruded into a building (such as a house) in which the home network 10 is build. In this case, the client terminal 200A judges that the server 100A is not properly working.

Note that, if the client terminal 200A has judged that the server 100A is not properly working, the client terminal 200A may establish a connection with a different sever connected with the home network 10, that is, the server 100B.

In Step S120, the client terminal 200A judges whether the client terminal 200A is provided with an alarm function for issuing an alarm that the server 100A is not properly working.

In this embodiment, since the client terminal 200A is provided with an alarm function (for example, an alarm device such as a siren), in Step S130, the client terminal 200A issues an alarm that the server 100A is not properly working by using the alarm function.

(2) Server

Next, with reference to FIG. 5, processing contents executed by the server 100A will be described. As shown in the drawing, in Step S210, the server 100A executes a start-up process. Specifically, the server 100A executes a process such as initialization of the respective logical blocks constituting the server 100A.

In Step S220, the server 100A receives from the client terminal 200A an advertise message containing TOPI which indicates a time-out period used for judging an interval between receptions of either CCI or normal information.

In Step S230, the server 100A stores in the date storing unit 103 the time-out period indicated by the received TOPI.

In Step S240, the server 100A resets a measurement of time-out period for CCI.

In Step S250, the server 100A judges whether there is a response from the client terminal 200A. Specifically, the server 100A judges whether the server 100A has received CCI or normal information from the client terminal 200A.

If there is no response from the client terminal 200A (“No” in Step S250), in Step S260, the server 100A judges whether the time-out period for CCI has elapsed.

If there is the response from the client terminal 200A (“Yes” in Step S250), in Step S255, the server 100A transmits to the client terminal 200A a response (a CCIRR or a response corresponding to the normal information) corresponding to the information (the CCI or the normal information) transmitted by the client terminal 200A. Subsequently, the server 100A repeats the steps from Step S240.

If the time-out period for CCI has elapsed (“Yes” in Step S260), in Step S270, the server 100A judges that a logical connection with the client terminal 200A is disconnected.

Incidentally, main causes for a disconnection of a logical connection with the client terminal 200A are physical isolation of the client terminal 200A from the home network 10 and shutoff of a power source for the client terminal 200A without a proper releasing process.

More specifically, it can be detected that the client terminal 200A is handled illegally by an intruder or the like who has intruded into a building (such as a house) in which the home network 10 is build. In this case, the server 100A judges that the client terminal 200A is not properly working.

In Step S280, the server 100A judges whether the client terminal 200A is a client terminal needing to alarm that the client terminal 200A is not properly working.

In this embodiment, since the server 100A needs to issue an alarm that the client terminal 200A is not properly working (“Yes” in Step S280), the server 100A issues an alarm that the client terminal 200A is not properly working.

Note that, in order for a different client terminal (for example, the client terminal 200B) to issue an alarm that the client terminal 200A is not properly working, the server 100A may transmit an instruction to the different client terminal.

(3) Communication Sequence

Next, a communication sequence between the server 100A and the client terminal 200A, which execute the abovementioned process, will be described.

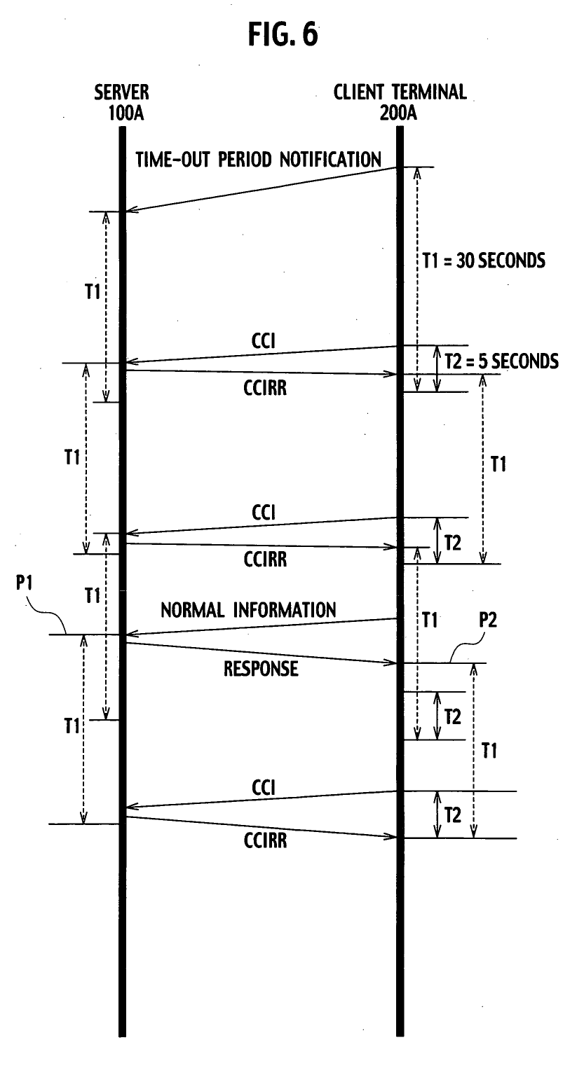

FIG. 6 shows a communication sequence in a case where a connection between the server 100A and the client terminal 200A is properly continued.

As shown in the drawing, within a time-out period T1 (30 seconds) for CCI, the client terminal 200A sequentially transmits CCI at timings whereby the client terminal 200A is allowed to receive a CCIRR corresponding to the CCI from the server 100A.

Specifically, in order to receive a CCIRR from the server 100A before an elapse of the time-out period T1, the client terminal 200A transmits CCI 5 seconds (a response reception time T2) before the elapse of the time-out period T1, and judges whether a CCIRR corresponding to the CCI by the time of elapse of the time-out period T1 is received.

If the client terminal 200A has received a CCIRR from the server 100A before the elapse of the time-out period T1, the client terminal 200A judges that a connection with the server 100A is properly continued. The client terminal 200A starts measurement of the time-out period T1 at the time of receiving a CCIRR from the server 100A.

On the other hand, if the server 100A has received CCI from the client terminal 200A before the elapse of the time-out period T1, the server 100A judges that a connection with the client terminal 200A is properly continued. The server 100A starts measurement of the time-out period T1 at the time of receiving CCI from the client terminal 200A.

Further, if there is normal information required to be transmitted to the server 100A other than CCI (for example, moving picture data captured by a security camera, with which the client terminal 200A is provided) transmitted by the client terminal 200A, the server 100A starts measurement of the time-out period T1 at the time of receiving the normal information from the client terminal 200A (P1 in FIG. 6).

Similarly, if the client terminal 200A has received a response corresponding to the normal information from the server 100A, the client terminal 200A starts measurement of the time-out period T1 at the time of receiving the response from the server 100A (P2 in FIG. 6).

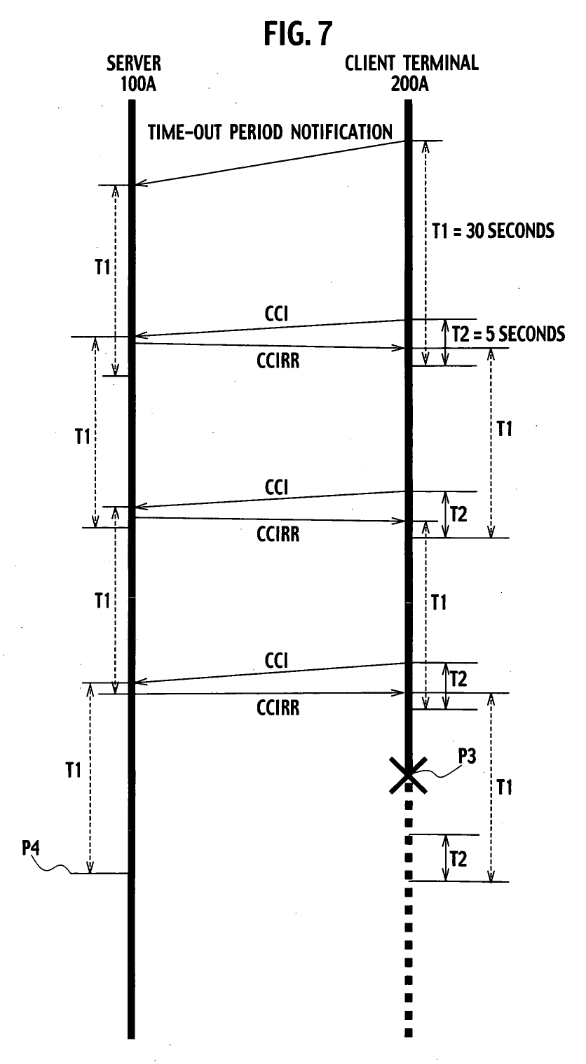

FIG. 7 shows a communication sequence in a case where a connection between the server 100A and the client terminal 200A is disconnected due to a cause related to the client terminal 200A.

The drawing indicates that, at a certain point (P3 in the drawing) of time during a state where a connection between the server 100A and the client terminal 200A has been established, the client terminal 200A is physically isolated from the home network 10, or, a power source for the client terminal 200A is shut off.

In this case, the server 100A becomes unable to receive CCI within the time-out period T1 whereas the server 100A has been properly received until the time point of P3. After an elapse of the time-out period T1 (P4 in the drawing), the server 100A judges that the connection with the client terminal 200A is disconnected. Subsequently, the server 100A issues an alarm that the client terminal 200A is not properly working.

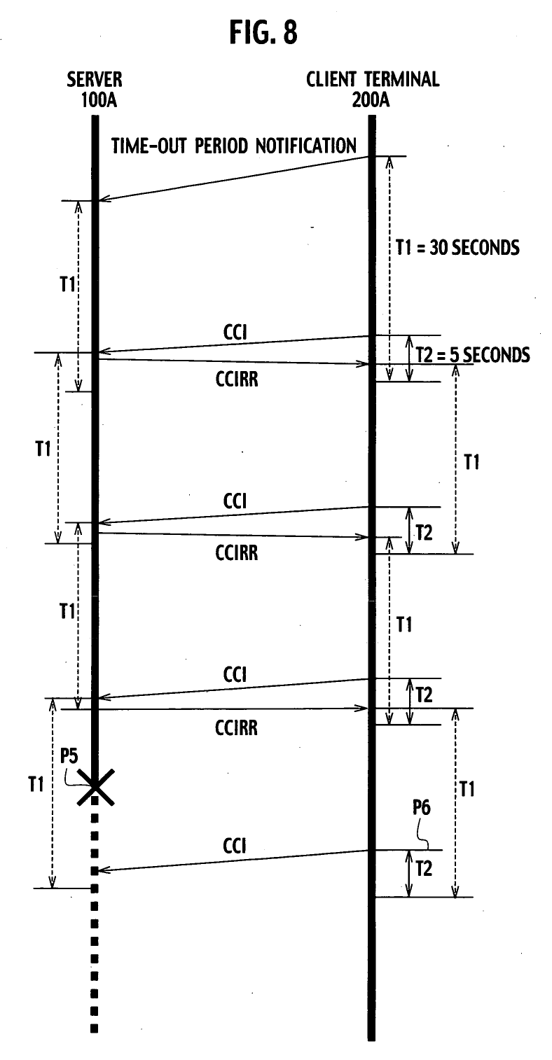

FIG. 8 shows a communication sequence in a case where a connection between the server 100A and the client terminal 200A is disconnected due to a cause related to the server 100A.

The drawing indicates that, at a certain point (P5 in the drawing) of time during a state where a connection between the server 100A and the client terminal 200A has been established, the server 100A is physically isolated from the home network 10, or, a power source for the server 100A is shut off.

In this case, if the client terminal 200A transmits CCI to the server 100A at a point (P6 in the drawing) of time after the time of P5, the client terminal 200A become unable to receive a CCIRR corresponding to the CCI transmitted at the time of P6 within the response reception time T2.

After an elapse of the response reception time T2 (that is, the time-out period T1), the client terminal 200A judges that the connection with the server 100A is disconnected. Subsequently, the client terminal 200A issues an alarm that the server 100A is not properly working.

(Operation and Effect)

According to the above-described information processing system of this embodiment, CCI is periodically transmitted from the client terminal to the server within a time-out period, which is used for judging that a connection between a client terminal (for example, the client terminal 200A) and a server (for example, the server 100A) is disconnected. Therefore, if the server cannot receive the CCI within the time-out period, the server can promptly judge that the connection is disconnected.

In other words, according to this information processing system, a disconnection of a logical connection between the client terminal and the server can be promptly detected even in a case where an interval between transmissions of information from the client terminal to the server is long.

According to this information processing system, since the server transmits a CCIRR to the client terminal, if the client terminal cannot receive the CCI, the client terminal can promptly judge that the connection is disconnected.

According to this information processing system, when a connection of the server with client terminal or vise versa is disconnected, and the client terminal or the server has been judged that it is not properly working, an alarm is issued. Therefore, a user and the like of the information processing system can promptly recognize the improperness. Further, in a case where a siren is used, it becomes possible to intimidate an intruder or the like who has intruded into a building (such as a house) in which the home network 10 is installed.

According to this information processing system, if the client terminal has judged that a connection with a server (for example, the server 100A) is disconnected, the client terminal establishes a connection with a different sever (the server 100B) connected to the home network 10. Therefore, a connection with a different sever can be established even when a certain server is not properly working.

(Modified Examples)

The present invention has been described above with reference to a certain embodiment. It should be noted, however, that the description and drawings constituting part of this disclosure shall not be deemed to limit the scope of the present invention. It is obvious to those skilled in the art that various substitutions and modifications are possible by the teaching of this specification.

For example, although the client terminals 200A and 200B are provided with a security camera function and the client terminal 300 is provided with a sensor function for measuring a temperature or the like in this embodiment, the client terminals 200A, 200B and 300 may be provided without these functions. Meanwhile, it is also possible to apply a personal computer or the like as the client terminal.

In addition, it is also possible to combine the features of the server 100A shown in FIG. 2 and the features of the client terminal 200A shown in FIG. 3 into one apparatus.

In the abovementioned embodiment of the present invention, both the client terminal and the server can detect a disconnection of a connection there between. However, only the server may detect a disconnection.

Further, the client terminal and the server may not necessarily be provided with alarm functions for issuing alarms about improperness of the server and the client terminal, respectively.

Moreover, although the time-out period T1 and the response reception period T2 are set to 30 seconds and 5 seconds, respectively, in the abovementioned embodiment of the present invention, they may be set to periods which are not 30 seconds and 5 seconds, respectively.

### Second Embodiment

Next, a second embodiment of the present invention will be described. Conventionally, in a general information processing system (a client server system) including a plurality of client terminal apparatuses, and a server apparatus with which the client terminal apparatuses are connected, the maximum number of the client terminal apparatuses connectable to the server apparatus (hereinafter, referred to as a “maximum connection number”) is determined in accordance with processing ability or the like of the server apparatus.

With this regard, there has been disclosed a method whereby: when a new client terminal has established a connection to the server apparatus, the server apparatus compares a number of already connected client terminal apparatuses (hereinafter, referred to as a “current connection number”) and the “maximum connection number”; and if the current connection number is equal to or greater than the maximum connection number, the server apparatus disconnects the connection with the new client terminal apparatus (see Japanese Unexamined Patent Publication No. 2001-160841 (page 4, FIG. 3)).

In this conventional method, it becomes clear whether a current connection number exceeds the maximum connection number after a client terminal apparatus has established a connection to a server apparatus. As a result, the server apparatus must perform a disconnection process with the client terminal apparatus every time when the current connection number exceeds the maximum connection number.

Specifically, the server apparatus must perform connection and disconnection processes with every client terminal apparatus, which is not connectable since the current connection number exceeds the maximum connection number. This leads a problem that a processing load on the server apparatus increases.

Accordingly, in this embodiment, a description will be given of an information processing system, a server apparatus and client terminal apparatuses, which can limit a number of the client terminal apparatuses connected with the server apparatus without increasing a processing load on the server apparatus.

(Overall Schematic Configuration of Information Processing System)

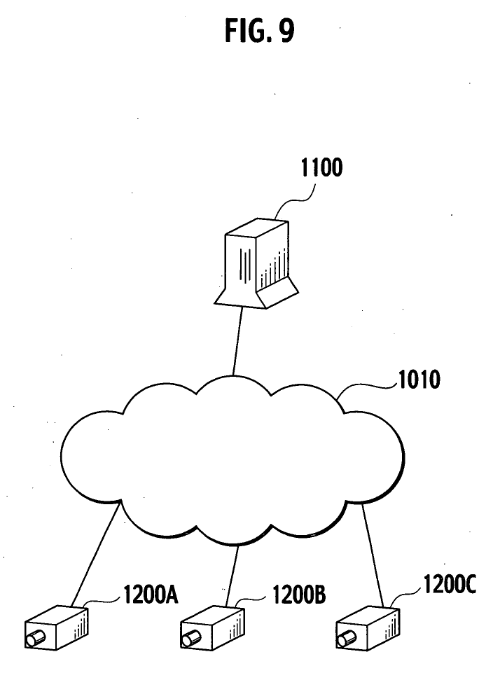

FIG. 9 shows an overall schematic configuration diagram of the information processing system according to this embodiment. As shown in the drawing, the information processing system according to this embodiment includes a server 1100 and client terminals 1200A to 1200C.

The server 1100 (the server apparatus) can connect with the client terminals 1200A to 1200C through a home network 1010, and executes predetermined processes together with the client terminals 1200A to 1200C.

The client terminals 1200A to 1200C (the client terminal apparatuses) can connect with the server 1100 through the home network 1010. In this embodiment, the client terminals 1200A to 1200C are provided with a security camera capable of capturing a location and its surroundings where the client terminal is placed.

The home network 1010 is a communication network for connecting the server 1100 and the client terminals 1200A to 1200C. The home network 1010 may be formed by use of a LAN (such as 100BASE-TX) installed in a building (such as a house). Note that the home network 10 may include a wireless LAN, and the home network 10 may be connected to a wide area network (WAN) or to the Internet.

(Logical Block Configuration)

Next, logical block configurations of the server 1100 and client terminals 1200A to 1200C which constitute the abovementioned information processing system will be described.

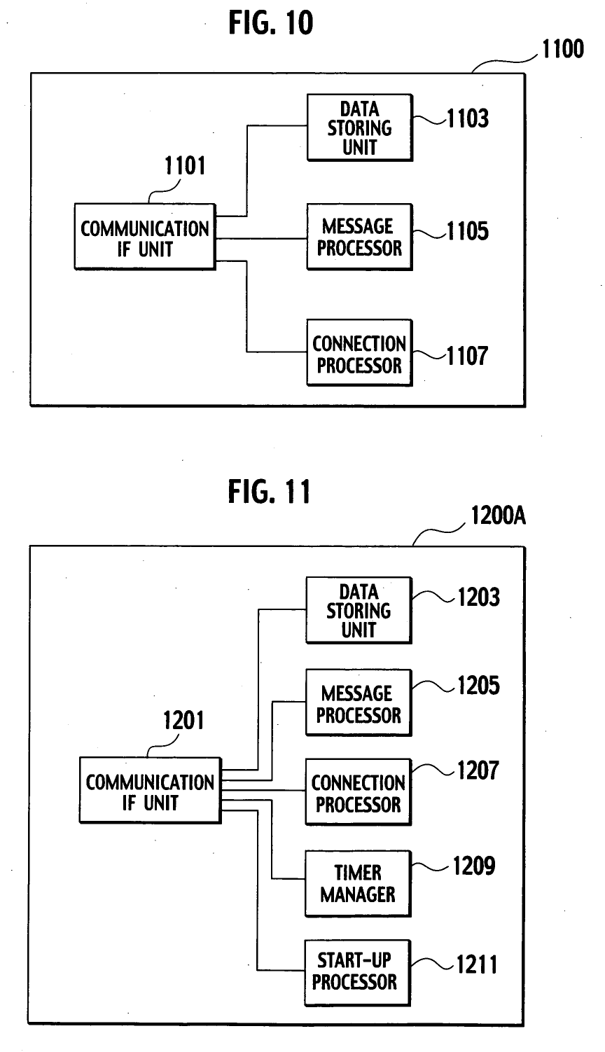

FIG. 10 shows a logical block configuration of the server 1100. Further, FIG. 11 shows a logical block configuration of the client terminal 1200A. Note that the client terminals 1200B and 1200C have a similar logic block configuration to the client terminal 1200A.

Now, portions related to the present invention will be mainly explained below. Accordingly, it should be noted that the server 1100 shown in FIG. 10 and the client terminal 1200A shown in FIG. 11 may further include un-illustrated or unexplained logic blocks (such are a power unit and the like) which are essential for realizing the features of the apparatuses.

(1) Server

As shown in FIG. 10, the server 1100 includes a communication IF unit 1101, a data storing unit 1103, a message processor 1105, and a connection processor 1107.

The communication IF unit 1101 provides a communication interface whereby the server 1100 connects with the home network 1010. Specifically, the communication IF unit 1101 is provided with a LAN interface (such as 100BASE-TX).

Further, the communication IF unit 1101 is connected with logical blocks of the data storing unit 1103, the message processor 1105 and the connection processor 1107. The communication IF unit 1101 relays data transmitted and received among these logical blocks and the home network 1010.

The data storing unit 1103 stores a “current connection number” (herein after referred to as “CCN”) indicating a number of the client terminals already connected with the server 1100, and a “maximum connection number” (hereinafter referred to as “MCN”) indicating the maximum number of the client terminals connectable to the server 1100.

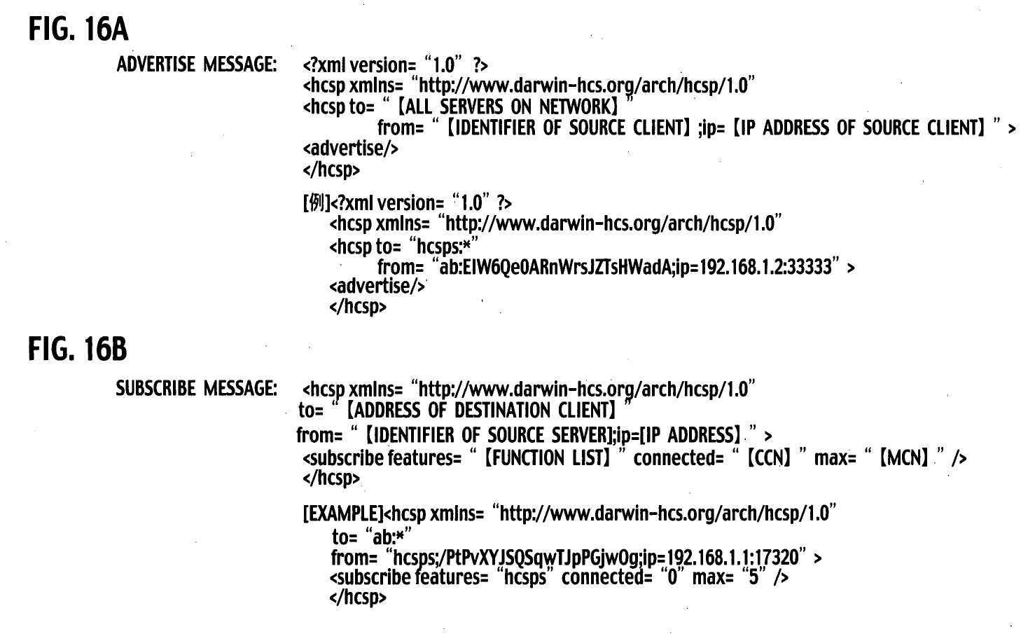

If the message processor 1105 has received an “advertise message” (refer to FIG. 16A) from the client terminal (for example, the client terminal 1200A) advertising a state of the client terminal, the message processor 1105 generates a “subscribe message” (refer to FIG. 16B) corresponding to the advertise message. Further, the message processor 1105 transmits the generated subscribe message to the one client terminal.

Particularly, if the message processor 1105 has received an advertise message (a network connection advertisement) from the client terminal advertising that the client terminal has connected with the home network 1010, the message processor 1105 advertises toward the client terminal a subscribe message (a connection number advertisement) containing a CCN indicating the number of the client terminals already connected with the server 1100, and the MCN indicating the maximum number of the client terminals connectable to the server 1100. In this embodiment, the message processor 1105 constitutes a connection number advertiser.

Specifically, the message processor 1105 advertises toward the client terminal the subscribe message (the connection number advertisement) by using a UDP (user datagram protocol).

The connection processor 1107 executes processes of establishing and disconnecting a logical connection with a client terminal (for example, the client terminal 1200A) to connect with the server 1100 by using a TCP (transmission control protocol).

Further, if a new client terminal connects with the server 1100, the connection processor 1107 updates the CCN stored in the data storing unit 1103.

(2) Client Terminal

As shown in FIG. 11, the client terminal 1200A includes a communication IF unit 1201, a data storing unit 1203, a message processor 1205, a connection processor 1207, a timer manager 1209, and a start-up processor 1211.

The communication IF unit 1201 provides a communication interface whereby the client terminal 1200A connects with the home network 1010. Specifically, the communication IF unit 1201 is provided with a LAN interface (such as 100BASE-TX).

Further, the communication IF unit 1201 is connected with logical blocks of the data storing unit 1203, the message processor 1205, the connection processor 1207, the timer manager 1209 and the start-up processor 1211. The communication IF unit 1201 relays data transmitted and received among these logical blocks and the home network 1010.

The data storing unit 1203 stores a subscribe message (a connection number advertisement) and the like received from the server 1100.

The message processor 1205 generates an advertise message advertising a state of the client terminal 1200A and the like. Further, the message processor 1205 transmits the generated advertise message to the server 1100.

Particularly, the message processor 1205 advertises toward the sever 1010 an advertise message (a network connection advertisement) advertising that the client terminal 1200A has connected with the home network 1010. In this embodiment, the message processor 1205 constitutes a network connection advertiser.

Specifically, the message processor 1205 advertises the advertise message (the network connection advertisement) by using a multicast UDP.

Additionally, the message processor 1205 receives and processes a subscribe message transmitted by the server 1100.

Further, the message processor 1205 receives from the server 1100 a subscribe message containing a CCN and the MCN. In this embodiment, an advertisement receiver is constituted of the communication IF unit 1201 and the message processor 1205.

If a reception waiting period for a subscribe message measured by the timer manager 1209 has elapsed, the message processor 1205 notifies the connection processor 1207 of contents of the CCN and the MCN, which numbers are contained in the received subscribe message.

The connection processor 1207 executes processes of establishing and disconnecting a logical connection with the server 1100 by using a TCP (transmission control protocol).

Further, based on a CCN and the MCN, which are contained in a subscribe message (a connection number advertisement) and transmitted from the server 1100, the connection processor 1207 judges whether a connection of the client terminal 1200A with the server 1100 is possible. In this embodiment, the connection processor 1207 constitutes a connection judger.

Specifically, if the CCN notified by the message processor 1205 is greater than or equal to the MCN, the connection processor 1207 judges that the connection with the server 1100 is impossible.

The timer manager 1209 manages a reception waiting period for a subscribe message corresponding to an advertise message transmitted from the message processor 1205. Specifically, the timer manager 1209 notifies the connection processor 1207 that the response waiting period has elapsed.

The start-up processor 1211 executes a start-up process required when the client terminal 1200A is started up (for example, when a power source is supplied). Specifically, the start-up processor 1211 executes initialization of the communication IF unit 1201 and the like, and checks, for example, whether the client terminal 1200A is physically connected with the home network 1010.

(Operations of Information Processing System)

Next, operations of the information processing system according to this embodiment will be described. Specifically, a description will be given of a process for judging whether the client terminal 1200A executes a logical connection based on a subscribe message transmitted by the server 1100 (a connection number advertisement).

(1) Outline of Process

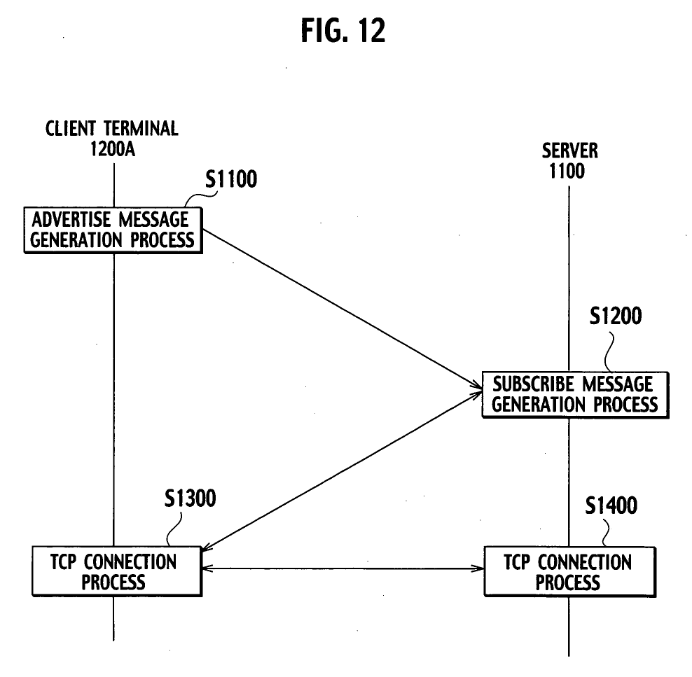

FIG. 12 is a sequence diagram showing an outline of a process executed by the information processing system according to this embodiment. As shown in the drawing, in Step S1110, the client terminal 1200A executes processing for generating an advertise message (a network connection advertisement) indicating that the client terminal 1200A has connected with the home network 1010.

In Step S1200, the server 1100 executes a process for generating a subscribe message (a connection number advertisement) corresponding to the advertise message (the network connection advertisement) transmitted by the client terminal 1200A.

In Step S1300, if the client terminal 1200A has judged that a connection with the server 1100 is possible based on the subscribe message transmitted by the server 1100 (the connection number advertisement), the client terminal 1200A executes a TCP connection process to establish a logical connection with the server 1100 by using a TCP.

In Step S1400, in response to a request for a connection to the server 1100 from the client terminal 1200A, the server 1100 executes a TCP connection process to establish a logical connection with the client terminal 1200A by using a TCP.

(2) Details of Process

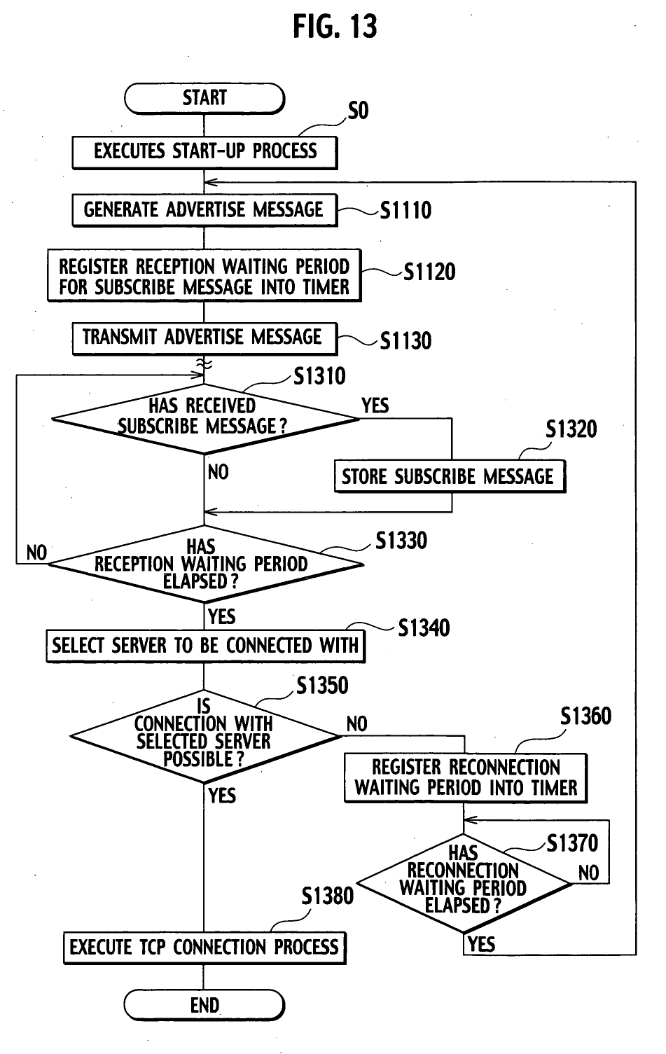

Next, with reference to FIGS. 13 to 15, specific process contents of the client terminal 1200A and the server 1100 in the respective abovementioned steps will be described. FIG. 13 shows an entire process flow in the client terminal 1200A.

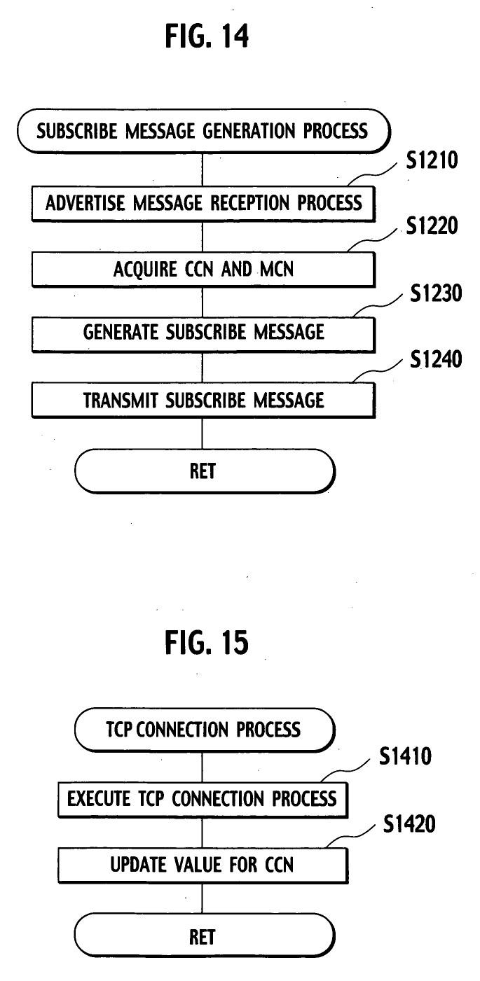

FIG. 14 shows a process flow of subscribe message generation in the server 1100. FIG. 15 shows a process flow of TCP connection in the server 1100.

As shown in FIG. 13, in Step S0, the client terminal 1200A executes a start-up process before the process for advertise message generation to be started in Step S1110. Specifically, the client terminal 1200A executes initialization of the communication IF unit 1201 and the like.

In Step S1110, the client terminal 1200A generates an advertise message (a network connection advertisement) indicating that the client terminal 1200A has connected with the home network 1010.

Specifically, the client terminal 1200A generates an advertise message as shown in FIG. 16A. The advertise message is written in accordance with an XML (extensible markup language), as shown in FIG. 16A.

The advertise message shown in FIG. 16A is transmitted from a specific address indicated by “from” (for example, 192.168.1.2) to unspecific addresses indicated by “to,” that is, to all of client terminals and servers connected with the home network 1010.

In Step S1120, the client terminal 1200A registers into a timer a reception waiting period for a subscribe message transmitted by the server 1100.

In Step S1130, the client terminal 1200A transmits the generated advertise message toward the server 1100. Specifically, the client terminal 1200A advertises the advertise message by using a multicast UDP.

Next, as shown in FIG. 14, in Step S1210, the server 1100 receives the advertise message transmitted by the client terminal 1200A.

In Step S1220, the server 1100 acquires a CCN and the MCN, which numbers are stored in the data storing unit 1103.

In Step S1230, the server 1100 generates a subscribe message (a connection number advertisement) by using the acquired CCN and the MCN.

Specifically, the server 1100 generates a subscribe message as shown in FIG. 16B. As shown in FIG. 16B, the subscribe message is written in accordance with the XML. The CCN is written in a position of “connected” shown in FIG. 16B. The MCN is written in a position of “max” shown in FIG. 16B.

In an example shown in FIG. 16B, “0” is written in “connected,” which indicates that there is no client terminal already connected with the server 1100. In the example shown in FIG. 16B, “5” is written in “max,” which indicates that the server 1100 can connect up to 5 client terminals simultaneously.

In Step S1240, the server 1100 transmits the generated subscribe message toward the client terminal 1200A. Specifically, the server 1100 advertises the subscribe message by using a UDP.

Next, as shown in FIG. 13, in Step S1310, the client terminal 1200A judges whether the subscribe message is received.

If the client terminal 1200A has received the subscribe message (“Yes” in Step S1310), in Step S1320, the client terminal 1200A stores the received subscribe message in the data storing unit 1203.

In Step S1330, the client terminal 1200A judges whether the reception waiting period for a subscribe message, which has been registered in Step S1120, has elapsed.

If the reception waiting period has elapsed (“Yes” in Step S1330), in Step S1340, the client terminal 1200A selects a server to connect with based on the received subscribe message.

Specifically, if the client terminal 1200A has received a plurality of subscribe messages from different servers, the client terminal 1200A selects, for example, the most functional server among them based on contents of function lists which indicate priority of servers (refer to FIG. 16B) contained in the respective subscribe messages. Here, it is assumed that the server 1100 is selected.

In Step S1350, the client terminal 1200A judges whether the client terminal 1200A can connect with the server 1100. Specifically, by comparing a CCN and the MCN contained in the subscribe message transmitted by the server 1100, the client terminal 1200A judges whether a connection with the server 1100 is possible.

For example, in a case where the MCN (“max”) is set to “5” as shown in FIG. 16B, it is judged that the connection with the server 1100 is impossible if the CCN (“connected”) is “5” or larger.

If the connection with the server 1100 is impossible (“No” in Step S1350), in Step S1360, the client terminal 1200A registers a reconnection waiting period into the timer.

In Step S1370, the client terminal 1200A judges whether the reconnection waiting period has elapsed.

If the re-connection waiting period has elapsed (“Yes” in Step S1370), the client terminal 1200A repeats the steps from Step S1120.

On the other hand, if the connection with the server 1100 is possible (“Yes” in Step S1350), in Step S1380, the client terminal 1200A executes a TCP connection process to establish a logical connection with the server 1100 by using a TCP.

Next, as shown in FIG. 15, in Step S1410, in response to a connection request from the client terminal 1200A, the server 1100 executes a TCP connection process to establish a logical connection with the client terminal 1200A by using a TCP.

In Step S1420, the server 1100 updates a value (for example, from “0” to “1”) for the CCN stored in the data storing unit 1103 based on establishment of the logical connection with the client terminal 1200A.

(Operation and Effect)

According to the above-described information processing system of this embodiment, the client terminal 1200A judges whether a connection with the server 1100 is possible based on the CCN and the MCN which are contained in a subscribe message (a connection number advertisement) transmitted by the server 1100. Therefore, when the server 1100 has already been connected with the MCN of the client terminals, a new client terminal is prevented from attempting to execute a connection with the server 1100 despite of the situation.

Specifically, according to this information processing system, the server 1100 is prevented from executing an unnecessary process of either connection or disconnection with a client terminal. Thus, it becomes possible to limit the number of connected client terminals to the MCN without increasing a processing load on the server 1100.

Further, according to this information processing system, by preventing the server 1100 from executing an unnecessary process of either connection or disconnection with a client terminal, it becomes possible to reduce an amount of data (a packet size) transmitted and received through the home network 1010. Therefore, a probability that the home network 1010 becomes congested can be reduced.

Moreover, according to this information processing system, since an advertise message and a subscribe message are transmitted and received by using a multicast UDP (for client to server direction) and a unicast UDP (for server to client direction), both of which are a low processing load, it becomes possible to reduce processing loads on the server 1100 and the client terminals 1200A to 1200C as compared with a case using a TCP.

(Modified Examples)

The present invention has been described above with reference to a certain embodiment. It should be noted, however, that the description and drawings constituting part of this disclosure shall not be deemed to limit the scope of the present invention. It is obvious to those skilled in the art that various substitutions and modifications are possible by the teaching of this specification.

For example, although each of the client terminals 1200A to 1200C is provided with a security camera in the abovementioned embodiment of the present invention, the client terminals 1200A to 1200C may be provided without a security camera function.

Meanwhile, it is also possible to apply a personal computer or the like as the client terminal.

In addition, it is also possible to combine the features of the server 1100 shown in FIG. 10 and the features of the client terminal 1200A shown in FIG. 11 into one apparatus.

Although in the abovementioned embodiment, the advertise message and the subscribe message are transmitted and received by using a multicast UDP or a unicast UDP, it is not necessarily required to use the multicast UDP or the UDP for transmitting and receiving these messages.

Further, the abovementioned embodiment of the present invention premises a configuration where only one server is put into operation (active) even when a plurality of servers are connected with the home network 1010. However, the present invention can be applied to a configuration where a plurality of servers is put into operation.

In the case where a plurality of servers are put into operation, any server which a CCN equals the MCN does not respond to an advertise message transmitted by a client terminal.

Note that, in order to change a state where a plurality of servers are put into operation to a state where only one server having the highest priority (for example, the most functional server) is put in operation for connecting client terminals, a server needs to respond to the advertise message even when a CCN equals the MCN.

More specifically, if the server which the CCN equals the MCN is the most functional server, it is required for a client terminal to continue selection of the server in order for the client terminal to stand by until the CCN of the server becomes smaller than the MCN.

In this manner, it is needless to say that the present invention encompasses various other embodiments which are not expressly stated herein. In this context, the technical scope of the present invention shall be solely determined by the matter to define the present invention relevant to the appended claims that deem to be appropriate in conjunction with the above descriptions.

1. An information processing system including a server apparatus and a plurality of client terminal apparatuses connected with the server apparatus through a communication network, wherein

the server apparatus comprises a connection number advertiser which advertises toward the client terminal apparatuses a connection number advertisement containing a CCN which indicates a number of the client terminal apparatuses already connected with the server apparatus and a MCN which is a maximum number of the client terminals connectable to the server apparatus, and

the client terminal apparatuses comprises a connection judger which judges whether a connection with the server apparatus is possible based on the CCN and the MCN contained in the connection number advertisement.

2. The information processing system of item 1, wherein the connection judger judges that the connection with the server apparatus is impossible if the CCN is equal to or larger than the MCN.

3. The information processing system of item 1 or 2, the client terminal apparatuses further comprises a network connection advertiser which advertises a network connection advertisement indicating that connection with the communication network is complete; and wherein
the connection number advertiser advertises the connection number advertisement in response to the network connection advertisement advertised by the client terminal.

4. The information processing system of either one of the items 1 to 3, the connection number advertiser advertises the connection number advertisement by using a UDP.

5. The information processing system of the item 3, the network connection advertiser advertises the network connection advertisement by using a UDP.

6. A server apparatus with which a plurality of client terminal apparatuses are connected through a communication network, comprising a connection number advertiser which advertises toward the client terminal apparatuses a connection number advertisement containing a CCN which indicates a number of the client terminal apparatuses already connected with the server apparatus and a MCN which is a maximum number of the client terminals connectable to the server apparatus.

7. The server apparatus of the item 6, wherein the connection number advertiser advertises the connection number advertisement by using a multicast UDP.

8. A client terminal apparatus which connects with a server apparatus through a communication network, comprising:

an advertisement receiver which receives a connection number advertisement which contains a CCN indicating a number of the client terminal apparatuses already connected with the server apparatus, and a MCN indicating A maximum number of client terminals connectable to the server apparatus; and

a connection judger which judges whether a connection with the server apparatus is possible based on the CCN and the MCN contained in the connection number advertisement.

9. The client terminal apparatus of the item 8, the connection judger judges that the connection to the server apparatus is impossible if the CCN is equal to or larger than the MCN.

10. The client terminal apparatus of the items 8 or 9, further comprising a network connection advertiser which advertises a network connection advertisement indicating that the connection with the communication network is complete.

11. The client terminal apparatuses of the item 10, wherein the network connection advertiser advertises the network connection advertisement by using a UDP.

What is claimed is:

1. An information processing system including a server apparatus and a client terminal apparatus which establishes a connection with the server apparatus through a communication network, wherein
the client terminal apparatus comprises:
a time-out period information transmitter configured to transmit a time-out period information indicating a time-out period used for judging that the connection has been disconnected from the server apparatus; and
a connection-continuation information transmitter configured to transmit a connection-continuation information indicating that the connection to the server apparatus is continued within the time-out period, and
the server apparatus comprises:
an information receiver configured to receive the time-out period information and the connection-continuation information; and
a disconnection judger configured to judge that the connection is disconnected if the information receiver cannot receive the connection-continuation information within the time-out period indicated by the time-out period information.

2. The information processing system of claim 1, wherein
the server apparatus further comprises a response transmitter configured to transmit a connection-continuation-information-reception response corresponding to received connection-continuation information to the client terminal apparatus, and
the client terminal apparatus further comprises:
a response receiver configured to receive the connection-continuation-information-reception response transmitted by the response transmitter; and
a client-side disconnection judger configured to judge that the connection is disconnected in a case where the response receiver cannot receive the connection-continuation-information-reception response transmitted next to the already received connection-continuation-information-reception response within a predetermined period after receiving an already received connection-continuation-information-reception response by the response receiver.

3. The information processing system of claim 1, wherein the server apparatus further comprises a disconnection alarm unit configured to issue an alarm that the connection is disconnected if the disconnection judger has judged that the connection is disconnected.

4. The information processing system of claim 2, the client terminal apparatus further comprises a client-side disconnection alarm unit configured to issue an alarm that the connection is disconnected if the client-side disconnection judger has judged that the connection is disconnected.

5. The information processing system of claim 2, the client terminal apparatus further comprises a connection establishment unit configured to establish a connection with a different server apparatus connected with the communication network if the client-side disconnection judger has judged that the connection is disconnected.

6. A server apparatus which establishes a connection with client terminal apparatuses through a communication network, comprising:
an information receiver configured to receive a time-out period information indicating a time-out period used for judging that the connection is disconnected, and a connection-continuation information indicating that the connection is continued; and
a disconnection judger configured to judge that the connection is disconnected if the information receiver cannot receive the connection-continuation information within the time-out period indicated by the time-out period information.

7. The server apparatus of claim 6, further comprising a response transmitter configured to transmit a connection-continuation-information-reception response corresponding to received connection-continuation information to the client terminal apparatus.

8. The server apparatus of claim 6, further comprising a disconnection alarm unit configured to issue an alarm that the connection is disconnected if the disconnection judger has judged that the connection is disconnected.

9. A client terminal apparatus which establishes a connection with a server apparatus through a communication network, comprising:
a time-out period information transmitter configured to transmit a time-out period information indicating a time-out period used for judging that the connection is disconnected from the server apparatus; and
a connection-continuation information transmitter configured to transmit a connection-continuation information indicating that the connection to the server apparatus is continued within the time-out period.

10. The client terminal apparatus of claim 9, further comprising:
a response receiver configured to receive the connection-continuation-information-reception response transmitted by the server apparatus; and
a client-side disconnection judger configured to judge that the connection is disconnected in a case where the response receiver cannot receive the connection-continuation-information-reception response transmitted next to the already received connection-continuation-information-reception response within a predetermined period after receiving an already received connection-continuation-information-reception response by the server apparatus.

11. The client terminal apparatus of claim 10, further comprising a client-side disconnection alarm unit configured to issue an alarm that the connection is disconnected if the client-side disconnection judger has judged that the connection is disconnected.

12. The client terminal apparatus of claim 10, further comprising a connection establishment unit configured to establish a connection with a different server apparatus connected with the communication network if the client-side disconnection judger has judged that the connection is disconnected.
